(19) United States
(12) Patent Application Publication
(10) Pub. No.: US 2013/0141321 A1
(43) Pub. Date: Jun. 6, 2013

(54) Driving Circuit, Liquid Crystal Panel, LCD, And Driving Method

(71) Applicants: Chenghung Chen, Shenzhen (CN); Zui Wang, Shenzhen (CN)

(72) Inventors: Chenghung Chen, Shenzhen (CN); Zui Wang, Shenzhen (CN)

(73) Assignee: Mitsubishi Electric Corporation, Chiyoda-ku (JP)

(21) Appl. No.: 13/378,770

(22) PCT Filed: Dec. 6, 2011
(86) PCT No.: PCT/CN11/83536

§ 371 Date: Dec. 16, 2011

(30) Foreign Application Priority Data
Dec. 2, 2011 (CN) 2011103961469

(51) Int. Cl. G09G 3/36

(52) U.S. Cl. 345/98

(57) ABSTRACT

The invention discloses a driving circuit, a liquid crystal panel, a liquid crystal display (LCD), and a driving method. A data driving circuit of a liquid crystal panel comprises a plurality of data driving chips. A plurality of first sub-voltage dividing circuits and second controllable sub-voltage dividing circuits are connected in series between said data driving chips and the common electrode of the liquid crystal panel, and each first sub-voltage dividing circuit and each second sub-voltage dividing circuit are connected by a data line of the liquid crystal panel. In the invention, two control voltages can be obtained only by controlling the second sub-voltage dividing circuit, which is only one distortion correction (Gamma) circuit used, thereby simplifying the circuit structure, saving PCB space, and reducing the cost.

### TECHNICAL FIELD

The invention relates to the field of liquid crystal displays, and more particularly to a driving circuit, a liquid crystal panel, an LCD (Liquid Crystal Display), and a driving method.

### BACKGROUND

Vertical Alignment (VA) LCD often has color washout when viewed in a wide angle. To improve the wide-angle display effect of a liquid crystal panel, some designs, called low color washout designs, are usually used to eliminate this phenomenon.

As shown in FIG. 1, take a conventional 2G1D (2 gate 1 data) structure as an example for description. The 2G1D structure is that one pixel has a main area and a sub area which are respectively controlled via two gate lines and TFTs to be on/off and charge the same data line.

For the pixel of 2G1D structure, the main area and the sub area shall display in different brightness to realize low color washout. A conventional method adopted is that when the TFTs of the main area and the sub area turn on, the main area and the sub area are respectively charged with different potentials to display in different brightness (See FIG. 2 for wave form).

To realize the above purpose, generally, two groups of distortion correction (Gamma) circuits are used respectively to correspond to signals of the main area and the sub area. This method has the disadvantages that an additional distortion correction chip (Gamma IC) and the corresponding resistor and capacitor are required to provide a second group of distortion correction (Gamma) circuit, and the source driver is also required to have the functions of corresponding to the two groups of distortion correction (Gamma) circuits, thereby increasing the cost.

### SUMMARY

The aim of the invention is to provide a driving circuit, a liquid crystal panel, an LCD, and a driving method with a simplified structure and low cost.

The purpose of the invention is achieved by the following technical schemes.

A data driving circuit of a liquid crystal panel, comprises a data driving chip; a plurality of voltage dividing circuits are connected in series between the data driving chip and a common electrode of the liquid crystal panel; each voltage dividing circuit is connected in series with a first sub-voltage dividing circuit and a second controllable sub-voltage dividing circuit; and each first sub-voltage dividing circuit and each second sub-voltage dividing circuit are connected by a data line of the liquid crystal panel.

Preferably, the first sub-voltage dividing circuit comprises a first thin film transistor, a source electrode of the first thin film transistor is connected with the data driving chip, a drain electrode thereof is connected with the second sub-voltage dividing circuit and the data line, and a gate electrode thereof is connected with high-level signals. This is one example of the first sub-voltage dividing circuit which can be formed during production of an array substrate without additional process.

Preferably, the first sub-voltage dividing circuit comprises a divider resistor, one end of the divider resistor is connected with the data driving circuit, and the other end is connected with the data line and the second sub-voltage dividing circuit. This is another example of the first sub-voltage dividing circuit, and the divider resistor is cheap, which can further reduce the cost.

Preferably, the second sub-voltage dividing circuit comprises a second thin film transistor, a source electrode of the second thin film transistor is connected with the first sub-voltage dividing circuit and the data line, a drain electrode thereof is connected with a common electrode of the liquid crystal panel, and a gate electrode thereof is connected with control signals. This is one example of the second sub-voltage dividing circuit which can be formed during production of an array substrate without additional process.

Preferably, the control signals are a clock control signal of the LCD panel. The clock control signals control the drive of a gate line. Thus, the control signals of the second thin film transistors are clock control signals, which provides better synchronization, simplifies the control mode, and reduces cost.

A liquid crystal panel, comprises a common electrode, a data driving chip, and a plurality of data lines, wherein each data line is connected with a plurality of pixel electrodes, each pixel electrode comprises a main pixel electrode and a sub pixel electrode, each main pixel electrode corresponds to a main gate line, and each sub pixel electrode corresponds to a sub gate line; the liquid crystal panel further comprises the data driving circuit of a liquid crystal panel, and each data line is connected between the first sub-voltage dividing circuit and the second sub-voltage dividing circuit of the data driving circuit.

An LCD comprises the liquid crystal panel.

A data driving method of an LCD comprises the following steps: starting a first sub-voltage dividing circuit and then a second sub-voltage dividing circuit within one data display cycle, starting a sub gate line driving corresponding to a sub pixel electrode during driving of the second sub-voltage dividing circuit, and closing a main gate line driving corresponding to a main pixel electrode.

Preferably, the first sub-voltage dividing circuits always remain in a starting state. It is required to control the second sub-voltage dividing circuit not the first sub-voltage dividing circuit, which simplifies the control mode and reduces cost.

Preferably, the first sub-voltage dividing circuit comprises a first thin film transistor, a source electrode of the first thin film transistor is connected with the data driving chip, a drain electrode thereof is connected with the second sub-voltage dividing circuit and the data line, and a gate electrode thereof is connected with high-level signals. This is one example of the first sub-voltage dividing circuit which can be formed during production of an array substrate without additional process.

Preferably, the first sub-voltage dividing circuit comprises a divider resistor, one end of the divider resistor is connected with the data driving circuit, and the other end is connected with the data line and the second sub-voltage dividing circuit. This is another example of the first sub-voltage dividing circuit, and the divider resistor is cheap, which can further reduce the cost.

Preferably, the second sub-voltage dividing circuit comprises a second thin film transistor, a source electrode of the second thin film transistor is connected with the first sub-voltage dividing circuit and the data line, a drain electrode thereof is connected with a common electrode of the liquid crystal panel, and a gate electrode thereof is connected with control signals. This is one example of the second sub-voltage dividing circuit which can be formed during production of an array substrate without additional process.

Preferably, the control signals are a clock control signal of the LCD panel. The clock control signals control the drive of a gate line. Thus, the control signals of the second thin film transistors are clock control signals, which provides better synchronization, simplifies the control mode, and reduces cost.

In the invention, due to the first sub-voltage dividing circuit and the second controllable sub-voltage dividing circuit connected in series, the first sub-voltage dividing circuit can provide a driving voltage for the main pixel electrode. The second sub-voltage dividing circuit is started only when it is required to drive the sub pixel electrode. The voltage of the data line decreases under the voltage division of the second sub-voltage dividing circuit. The sub gate line driving corresponding to the sub pixel electrode is started synchronously to drive the sub pixel electrode to display, and the main gate line driving corresponding to the main pixel electrode is closed, so different voltage can be obtained by controlling the second sub-voltage dividing circuit to be on/off, and the main area and the sub area can display in different brightness, so as to achieving low color washout. In the invention, two control voltages can be obtained only by controlling the second sub-voltage dividing circuit, which is only one distortion correction (Gamma) circuit used, thereby simplifying the circuit structure, saving PCB space, and reducing cost.

### DESCRIPTION OF FIGURES

FIG. 1 is a schematic diagram of a liquid crystal panel with a 2G1D structure.

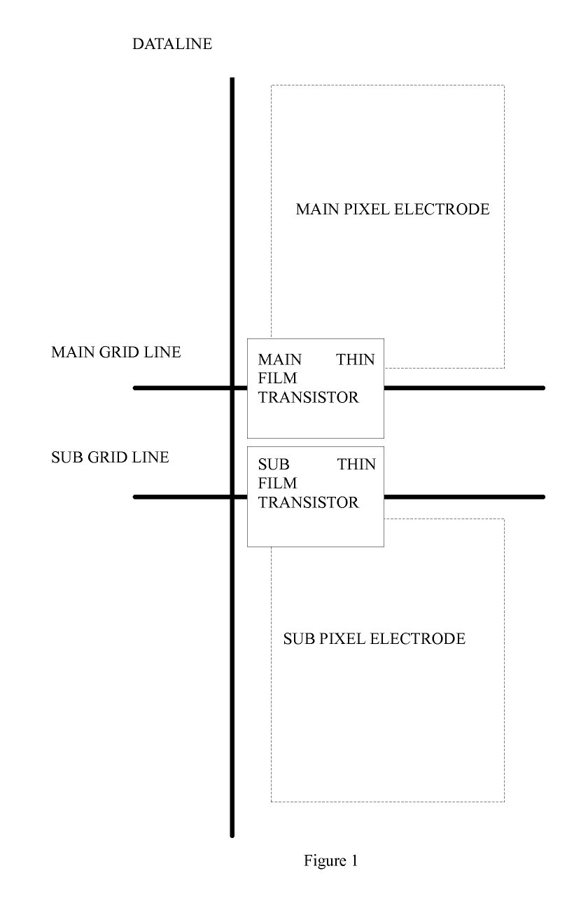

FIG. 2 is a schematic diagram of driving of a liquid crystal panel with a 2G1D structure.

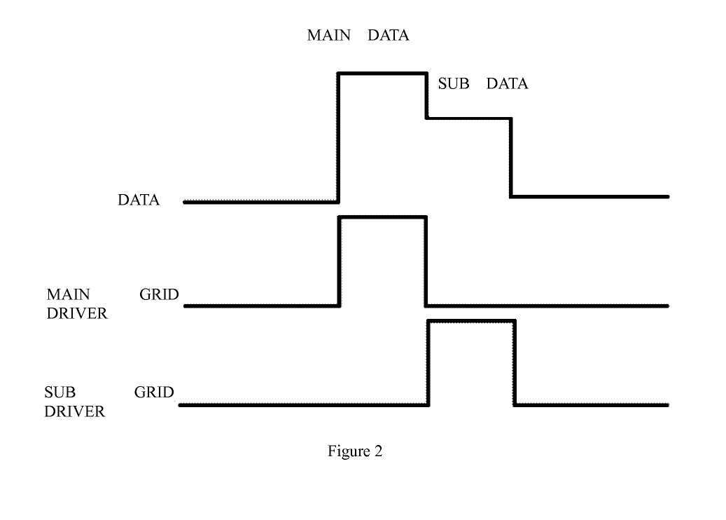

FIG. 3 is a schematic diagram of a data driving circuit of the invention.

FIG. 4 is a schematic diagram of a data driving method of the invention.

### DETAILED DESCRIPTION

The invention is further described by figures and the preferred embodiments as follows.

An LCD comprises a liquid crystal panel. The liquid crystal panel comprises data lines, gate lines, and pixel electrodes. Each pixel electrode comprises a main pixel electrode and a sub pixel electrode. Each main pixel electrode corresponds to a main gate line, and each sub pixel electrode corresponds to a sub gate line. This is one example of the liquid crystal panel. The liquid crystal panel further comprises a data driving circuit. The data driving circuit comprises a data driving chip; a plurality of first sub-voltage dividing circuits and second controllable sub-voltage dividing circuits are connected in series between the data driving chip and the common electrode of the liquid crystal panel; and each first sub-voltage dividing circuit and each second sub-voltage dividing circuit are connected by a data line.

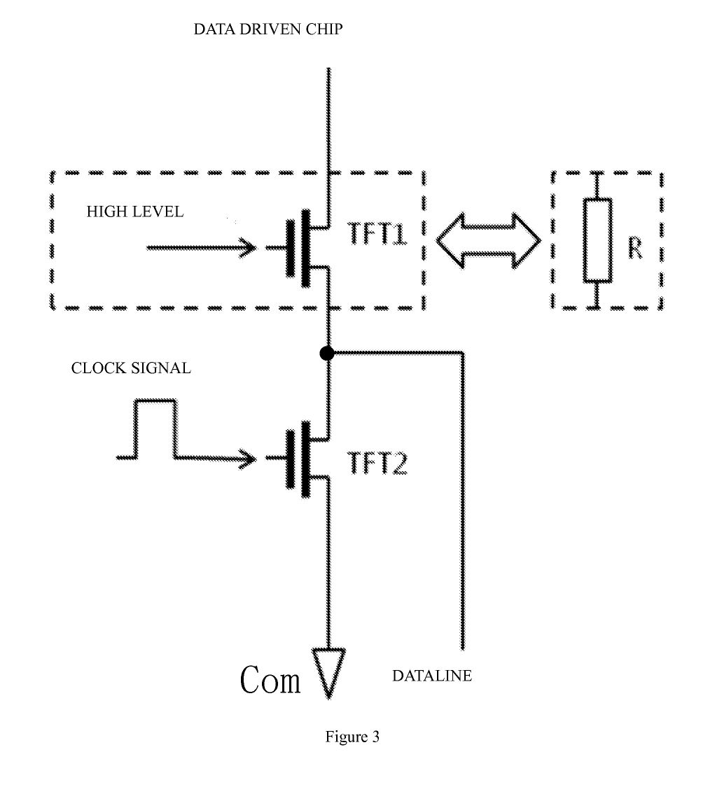

As shown in FIG. 3, the first sub-voltage dividing circuit comprises a first thin film transistor (TFT1), and the second sub-voltage dividing circuit comprises a second thin film transistor (TFT2). A source electrode of the first thin film transistor (TFT1) is connected with the data driving chip; a drain electrode thereof is connected with a source electrode of the second thin film transistor (TFT2) and the data line, and a gate electrode thereof is connected with high-level signals. A drain electrode of the second thin film transistor (TFT2) is connected with the common electrode of the liquid crystal panel, and the gate electrode is connected with control signals. Optionally, the first sub-voltage dividing circuit can also use a divider resistor. One end of the divider resistor is connected with the data driving circuit, and the other end is respectively connected with the source electrode of the second thin film transistor (TFT2) and the data line.

The control signals are a clock control signal of the LCD panel. The clock control signals control the gate line driving. That the control signals of the second thin film transistor (TFT2) are clock control signals provides better synchronization, simplifies the control mode, and reduces the cost.

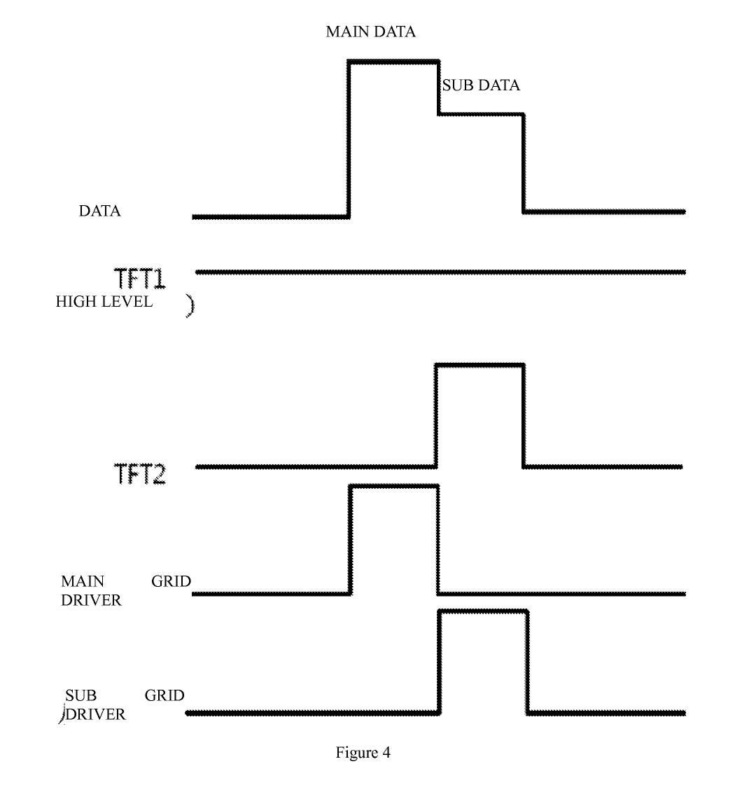

As shown in FIG. 4, start the first thin film transistor (TFT1) and then the second thin film transistor (TFT2) within one data display cycle, start the sub gate line driving corresponding to the sub pixel electrode during driving of the second thin film transistor (TFT2), and close the main gate line driving corresponding to the main pixel electrode.

The first thin film transistors (TFT1) can always remain in a starting state, which simplifies the control mode and reduces the cost.

Data signals pass through a structure formed by connecting in series two TFTs with different W/L after output from the data driving chip (Source IC). The potential of the TFT1 gate is increased, one clock control signal is input to the TFT2 gate, and the lower end is connected to the common (Com) electrode. When the driving (Main TFT) of the main pixel electrode is on, the potential of the TFT2 gate is reduced, and the data input to the main pixel has high potential. When the driving (Sub TFT) of the sub pixel electrode is started, the potential of the TFT2 gate is increased, and the voltage is divided by two TFTs (or resistor and TFT2), which can make the data input to the sub pixel have a low potential so as to achieve different display brightness of the main pixel and sub pixel.

In the invention, due to the first sub-voltage dividing circuit and the second controllable sub-voltage dividing circuit connected in series, the first sub-voltage dividing circuit can provide a driving voltage for the main pixel electrode. The second sub-voltage dividing circuit is started only when it is required to drive the sub pixel electrode. The voltage of the data line decreases under the voltage division of the second sub-voltage dividing circuit. The sub gate line driving corresponding to the sub pixel electrode is started synchronously to drive the sub pixel electrode to display, and the main gate line driving corresponding to the main pixel electrode is closed, so different voltage can be obtained by controlling the second sub-voltage dividing circuit to be on/off, and the main area and the sub area can display in different brightness, so as to achieving low color washout. In the invention, two control voltages can be obtained only by controlling the second sub-voltage dividing circuit, which is only one distortion correction (Gamma) circuit used, thereby simplifying the circuit structure, saving PCB space, and reducing cost.

The above content is detailed description of the invention by using specific preferred embodiments. However, this invention is not limited to these specific embodiments. For the ordinary technical personnel in the technical field of the invention, on the premise of keeping the conception of the invention, the technical personnel can also make simple deductions or replacements, and all of which should be considered to belong to the protection scope of the invention.

1. A data driving circuit of the liquid crystal panel, comprising a data driving chip; wherein a plurality of voltage dividing circuits are connected in series between the data driving chip and a common electrode of the liquid crystal panel; each voltage dividing circuit is connected in series with a first sub-voltage dividing circuit and a second controllable sub-voltage dividing circuit; and each first sub-voltage dividing circuit and each second sub-voltage dividing circuit are connected by a data line of the liquid crystal panel.

2. The data driving circuit of the liquid crystal panel of claim 1, wherein said first sub-voltage dividing circuit comprises a first thin film transistor, a source electrode of the first thin film transistor is connected with the data driving chip, a drain electrode thereof is connected with the second sub-voltage dividing circuit and the data line, and a gate electrode thereof is connected with high-level signals.

3. The data driving circuit of the liquid crystal panel of claim 1, wherein said first sub-voltage dividing circuit comprises a divider resistor, one end of the divider resistor is connected with the data driving circuit, and the other end is connected with the data line and the second sub-voltage dividing circuit.

4. The data driving circuit of the liquid crystal panel of claim 1, wherein said second sub-voltage dividing circuit comprises a second thin film transistor, a source electrode of the second thin film transistor is connected with the first sub-voltage dividing circuit and the data line, a drain electrode thereof is connected with a common electrode of the liquid crystal panel, and a gate electrode thereof is connected with control signals.

5. The data driving circuit of the liquid crystal panel of claim 4, wherein said control signals are clock control signals of the LCD panel.

6. A liquid crystal panel, comprising a common electrode, a data driving chip, and a plurality of data lines, wherein each data line is connected with a plurality of pixel electrodes, each pixel electrode comprises a main pixel electrode and a sub pixel electrode, each main pixel electrode corresponds to a main gate line, and each sub pixel electrode corresponds to a sub gate line; the liquid crystal panel further comprises a data driving circuit of a liquid crystal panel; the data driving circuit comprises a data driving chip; a plurality of voltage dividing circuits are connected in series between the data driving chip and a common electrode of the liquid crystal panel; each voltage dividing circuit is connected in series with a first sub-voltage dividing circuit and a second controllable sub-voltage dividing circuit; and each first sub-voltage dividing circuit and each second sub-voltage dividing circuit are connected by a data line of the liquid crystal panel, and each data line is connected between the first sub-voltage dividing circuit and the second sub-voltage dividing circuit of the data driving circuit.

7. The liquid crystal panel of claim 6, wherein said first sub-voltage dividing circuit comprises a first thin film transistor, a source electrode of the first thin film transistor is connected with the data driving chip, a drain electrode thereof is respectively connected with the second sub-voltage dividing circuit and the data line, and a gate electrode thereof is connected with high-level signals.

8. The liquid crystal panel of claim 6, wherein said first sub-voltage dividing circuit comprises a divider resistor, one end of the divider resistor is connected with the data driving circuit, and the other end is connected with the data line and the second sub-voltage dividing circuit.

9. The liquid crystal panel of claim 6, wherein said second sub-voltage dividing circuit comprises second a thin film transistor, a source electrode of the second thin film transistor is connected with the first sub-voltage dividing circuit and the data line, a drain electrode thereof is connected with a common electrode of the liquid crystal panel, and a gate electrode thereof is connected with control signals.

10. The liquid crystal panel of claim 9, wherein said control signals are clock control signals of the LCD panel.

11. An LCD, comprising a liquid crystal panel of claim 6.

12. A data driving method of an LCD comprising the following steps: starting a first sub-voltage dividing circuit and then a second sub-voltage dividing circuit within one data display cycle, starting a sub gate line driving corresponding to a sub pixel electrode during driving of the second sub-voltage dividing circuit, and closing a main gate line driving corresponding to a main pixel electrode.

13. The data driving method of an LCD of claim 12, wherein said first sub-voltage dividing circuits always remain in a starting state.

14. The data driving method of an LCD of claim 12, wherein said first sub-voltage dividing circuit comprises a first thin film transistor, a source electrode of the first thin film transistor is connected with the data driving chip, a drain electrode thereof is connected with the second sub-voltage dividing circuit and the data line, and a gate electrode thereof is connected with high-level signals.

15. The data driving method of an LCD of claim 12, wherein said first sub-voltage dividing circuit comprises a divider resistor, one end of the divider resistor is connected with the data driving circuit, and the other end is connected with the data line and the second sub-voltage dividing circuit.

16. The data driving method of an LCD of claim 12, wherein said second sub-voltage dividing circuit comprises a second thin film transistor, a source electrode of the second thin film transistor is connected with the first sub-voltage dividing circuit and the data line, a drain electrode thereof is connected with the common electrode of the liquid crystal panel, and a gate electrode thereof is connected with control signals.

17. The data driving method of an LCD of claim 12, wherein said control signals are clock control signals of the LCD panel.
